(19) United States
(12) Patent Application Publication
(10) Pub. No.: US 2025/0052884 A1
(43) Pub. Date: Feb. 13, 2025

(54) BUILDING OCCUPANCY ESTIMATION USING MICROWAVE DOPPLER RADAR AND TIME-FREQUENCY SPECTRAL ANALYSIS

(71) Applicants: Amy Diane Droitcour, Lafayette, CO (US); Shekh Md Mahmudul Islam, Badda (BD)

(72) Inventors: Amy Diane Droitcour, Lafayette, CO (US); Shekh Md Mahmudul Islam, Badda (BD)

(21) Appl. No.: 17/574,442

(22) Filed: Jan. 12, 2022

Related U.S. Application Data
(60) Provisional application No. 63/152,242, filed on Feb. 22, 2021.

(51) Int. Cl. G01S 13/56; F24F 120/10; G01S 7/41; G01S 13/02

(52) U.S. Cl. CPC G01S 13/56; G01S 7/415; G01S 13/0209; F24F 2120/10

(57) ABSTRACT

RADAR-based occupancy detection and estimation is provided that is unobtrusive and does not introduce privacy issues. Time-frequency spectral analysis signal processing techniques are used for counting the number of people utilizing microwave Doppler RADAR. A RADAR-based hardware system determines the frequency at which highest amplitude occurs of a segmented portion of the signal obtained. The time-frequency spectral analysis on the signal is used to determine the number of occupants in a room.

### CROSS-REFERENCE TO RELATED APPLICATIONS

This application claims benefit under 35 U.S.C. § 119 (e) of U.S. Provisional Application having Ser. No. 63/113,066 filed Nov. 12, 2020, and U.S. Provisional Application having Ser. No. 63/152,242 filed Feb. 22, 2021, which are hereby incorporated by reference herein in their entirety.

### BACKGROUND

The embodiments herein relate generally to detection systems, and more particularly, to detecting occupancy of a room.

Residential and commercial buildings account for of 40% of the total amount of energy used worldwide. Globally 28% of CO2 emissions are caused by buildings, mostly from climate control. Sensing demand in residential and commercial buildings and adjusting energy consumption accordingly is gaining attention as a method to reduce wasted energy. Occupancy-driven building climate control systems control HVAC (Heating, Ventilation, and Air Conditioning) systems by estimating the number of occupants in the building or zone and providing the appropriate amount of ventilation for these occupants rather than ventilating at a rate set for the maximum occupancy. Moreover, occupancy estimation and detection in commercial and residential buildings can play an important role in security management and emergency evacuations and can enable monitoring of the ability of occupants to maintain physical distance when necessary for safety in a pandemic with the airborne viral transmission.

Roughly 44% of all energy used in commercial buildings goes toward HVAC. Much of this energy is wasted because ventilation is set at levels for the maximum occupancy for which the buildings are designed, but buildings are occupied well below the maximum levels at almost all times. When a building is ventilated at a higher rate than required for the number of occupants, thermal energy is wasted by heating or cooling more outside air than required, and mechanical energy is wasted by running fans at a higher rate than required.

A Demand-controlled ventilation (DCV) offers the potential to achieve energy savings by optimizing the outdoor ventilation airflow provided to a building based on the number of occupants. This saves both fan power and the energy cost of heating and cooling the outdoor air. However, it is critical not to under-ventilate spaces, as poor air quality has been shown to adversely impact decision-making performance and productivity, and very high levels of CO2 can be dangerous.

Motion-sensing occupancy sensors, such as those using passive infrared (PIR) and ultrasound (US), are popular as a means to control lighting to save energy, although they have significant failure rates when occupants are sedentary. Because these systems only detect whether or not someone is moving in space, and cannot estimate the number of people present, they have very limited application in DCV systems, as they are only useful in single-occupancy rooms, such as private offices. Even in single-occupancy rooms, they risk underventilation when a sedentary occupant causes a false vacancy signal. Occupancy schedules can be suitable for demand-controlled ventilation in spaces for which occupancy levels change on a predictable basis, such as in some classrooms. Spaces with irregular or unforeseen occupancy fluctuations (such as open offices, meeting rooms, performance venues, lobbies, transient spaces, and retail outlets) need a real-time, accurate estimate of the number of occupants for a DCV system to provide the right level of ventilation, maximizing energy savings while maintaining air quality.

Currently, carbon dioxide (CO2) sensors are the most used method of estimating room occupant count, based on the fact that the rate of CO2 generation indoors by occupants is proportional to the number of occupants and their activity levels. However, the CO2-based DCV market has grown slowly since 1990. Studies have indicated that there are numerous issues with CO2 sensors that need to be addressed, including the accuracy of the sensors, maintenance/calibration requirements, and the sensor lag times. Also, the CO2 generation rates measured and reported for sedentary adults (1.2 met units) need to be adjusted for other situations, such as children in classrooms.

Advanced occupant counting sensors that provide an instantaneous, accurate estimate of the number of people present in a room can enable DCV systems to meet their true potential for energy savings and reliability. Technologies currently available and new technologies in development include video-based computer vision systems, doorway sensors using different technologies to detect persons entering or leaving a room, sensors integrated into floor tiles, and arrays of time-of-flight sensors in ceiling tiles. Many people are uncomfortable with the privacy risks of ubiquitous video-based sensors, even if they are designed not to record any images, and this has slowed the uptake of these sensors. Video-based counting systems are expensive and can only accurately count moving occupants. Doorway sensors are not always accurate at determining whether people are entering or leaving, and errors in count accumulate through the day and are further complicated when spaces have multiple doorways; they are suitable for determining the flow of people in space but insufficiently accurate for broad use in DCV systems. Systems that require arrays of sensors in the floor or ceiling are expensive and complicated to install, especially in retrofit applications. Received signal strength (RSS) of WiFi signals have been used to measure the number of occupants; however, this method is not accurate if one occupant blocks the line of sight (LOS) for another occupant. New technologies and algorithms are necessary to accurately determine occupant presence and number while protecting privacy, at a reasonable installation cost.

### SUMMARY

In one aspect of the subject technology, a method for determining occupancy in a room is disclosed. The method includes operating a RADAR based sensor to detect human movement in a room. A baseband signal is received from the RADAR based sensor. A segment of the baseband signal is extracted. A portion of the segment is extracted. A time-frequency spectral analysis is applied to the extracted portion. A distribution of signal amplitude over frequencies and time in the extracted segment is identified based on the time-frequency spectral analysis. A number of occupants present in the room is determined based on parameters associated with the distribution of signal amplitude over frequencies and time.

In another aspect, a system for detecting occupancy in a room is disclosed. The system includes a RADAR based sensor. A computing device is connected to the RADAR based sensor. The computing device includes a processor configured to operate a RADAR based sensor to detect human movement in a room. A baseband signal is received from the RADAR based sensor. A segment of the baseband signal is extracted. A portion of the segment is extracted. A time-frequency spectral analysis is applied to the extracted segment. A distribution of signal amplitude over frequencies and time in the extracted segment is identified based on the time-frequency spectral analysis. A number of occupants present in the room is determined based on parameters associated with the distribution of signal amplitude over frequencies and time.

In yet another aspect, a system for detecting occupancy in a room is disclosed. The RADAR-based sensor system includes a local oscillator, a power splitter, and a mixer. The local oscillator generates a radio signal, which is split into a first portion of the radio signal and a second portion of the radio signal. The first portion of the radio signal is sent to an antenna to drive an emitted detection signal, and generates a return signal from one or more objects in the room. The return signal is received by the antenna. The second portion of the radio signal from the local oscillator and the return signal are sent to the mixer. The mixer generates an output as a product of the second portion of the radio signal from the local oscillator and the return signal. A baseband signal conditioning circuit is disposed to receive an output from the mixer and to filter and amplify the mixer output to generate a baseband signal. A baseband signal from the baseband signal conditioning circuit is digitized by a data acquisition circuit. A computing device is connected to the data acquisition circuit and the digitized signal is processed by a processor in the computing device. The processor extracts a segment of the baseband signal; extracts a portion of the segment; applies a wavelet transform to the extracted periodic portion of the segment; identifies the frequency of the maximum wavelet coefficient of the extracted portion of the segment; determines a number of occupants present in the room based on the frequency of the maximum wavelet coefficient; and uses the number of occupants as an input to control an environment of the room.

### BRIEF DESCRIPTION OF THE FIGURES

The detailed description of some embodiments of the invention is made below with reference to the accompanying figures, wherein like numerals represent corresponding parts of the figures.

FIG. 1. is a schematic diagram of a RADAR receiver in accordance with an embodiment of the subject technology.

FIG. 2A, FIG. 2B, FIG. 2C, and FIG. 2D are a group of plots for different mother wavelets used in accordance with embodiments of the subject technology.

FIG. 3 is a group of plots showing real and imaginary parts of the Morlet wavelet with an effective support of [−4 4] and a FFT of the real part of the Morlet wavelet with an effective support of [−4 4].

FIG. 4 is a group of plots showing real and imaginary parts of the Morlet wavelet with an effective support of [−8 8] and a FFT of the real part of the Morlet wavelet with an effective support of [−8 8].

FIG. 5A is a plot of a signal containing mixture of sinusoids at frequencies of 0.2 Hz and 0.3 Hz

FIG. 5B is a plot of a local oscillator signal of 2.4 GHz.

FIG. 5C is a plot of a combined mixture of LO and mixture of sinusoidal signals.

FIG. 5D is a plot of a Taylor series of the combined mixture signal of FIG. 5C.

FIG. 5E is a plot of the FFT of the Taylor series of combined mixture of LO and RF signals in FIG. 5D.

FIG. 6A is a wavelet scalogram for extracting the frequency of the maximum wavelet coefficient of the Taylor series of the combined mixture of LO and RF signals where the extracted frequency of the maximum wavelet coefficient is 0.2 Hz for a single frequency.

FIG. 6B is a wavelet scalogram for extracting the frequency of the maximum wavelet coefficient of the Taylor series of the combined mixture of LO and RF signals where the RF signal is a mixture of the LO and nine frequencies in the respiration band and where the extracted frequency of the maximum wavelet coefficient is 2.153 Hz.

FIG. 6C is a wavelet scalogram for extracting the frequency of the maximum wavelet coefficient of the Taylor series of the combined mixture of LO and RF signals where the signals the RF signal is a mixture of the LO and ten frequencies in the respiration band and the extracted frequency of the maximum wavelet coefficient is 2.473 Hz for combining ten different frequencies.

FIG. 7A is a block diagram of a system for determining occupancy in a room in accordance with embodiments of the subject technology.

FIG. 7B is a block diagram of a system for detecting occupancy in a room in accordance with embodiments of the subject technology.

FIG. 8A is an illustration view of an unoccupied room set up with a system for determining occupancy according to an embodiment.

FIG. 8B is an illustration view of an example occupied room being monitored according to embodiments.

FIG. 9A is a plot of a RADAR captured signal for a Raw I channel signal in embodiments of the subject technology.

FIG. 9B is a plot of a RADAR captured signal for a filtered I channel signal in embodiments of the subject technology.

FIG. 9C is a plot of a RADAR captured signal for a Raw Q channel signal in embodiments of the subject technology.

FIG. 9D is a plot of a RADAR captured signal for a filtered Q channel signal in embodiments of the subject technology.

FIG. 10A is a plot of a linearly demodulated signal of the segmented portion when the number of occupants in a room was a single subject according to embodiments of the subject technology.

FIG. 10B is a plot of a linearly demodulated signal of the segmented portion when the number of occupants in a room included ten subjects according to embodiments of the subject technology.

FIG. 10C is a plot of an FFT of the linearly demodulated signal of the segmented portion when the number of occupants in a room was a single subject according to embodiments of the subject technology.

FIG. 10D is a plot of an FFT of the linearly demodulated signal of the segmented portion when the number of occupants in a room included ten subjects according to embodiments of the subject technology.

FIG. 11A is a plot of a continuous wavelet transform with the effective support of eight ([−4 4]) of the segmented portion of the signal when there was a single occupant in a room according to embodiments of the subject technology.

FIG. 11B is a plot of a continuous wavelet transform with the effective support of eight ([−4 4]) of the segmented portion of the signal when there were ten occupants in a room according to embodiments of the subject technology.

FIG. 12A is a plot of a continuous wavelet transform with the effective support of sixteen ([−8 8]) of the segmented portion of the signal when there was a single occupant in a room according to embodiments of the subject technology.

FIG. 12B is a plot of a continuous wavelet transform with the effective support of sixteen ([−8 8]) of the segmented portion of the signal when there were ten occupants in a room according to embodiments of the subject technology.

FIG. 13A and FIG. 13B show a side by side comparison of two plots with different effective supports, showing a relationship between the frequency of the maximum wavelet coefficient of the segmented portion of the signal, and the number of occupants in a room according to embodiments of the subject technology.

FIG. 14 is a plot of comparative analysis between frequency of the maximum wavelet coefficient and received signal strength (RSS) with the number of occupants according to embodiments of the subject technology.

FIG. 15A is a plot of wavelet analysis for variable window size for the segmented portion of one subject with a 30 second window where the highest signal content is at a frequency of 0.356 Hz according to embodiments of the subject technology.

FIG. 15B is a plot of wavelet analysis for variable window size of the segmented portion for nine subjects with a 30 second window having highest signal content is at a frequency of 3.748 Hz according to embodiments of the subject technology.

FIG. 15C is a plot of wavelet analysis for variable window size of the segmented portion for nine subjects with a 45 second window having highest signal content at a frequency of 3.497 Hz according to embodiments of the subject technology.

FIG. 16A is a plot showing a relationship between the frequency of the maximum wavelet coefficient and occupant count with window length set at 20 seconds according to embodiments of the subject technology.

FIG. 16B is a plot showing a relationship between the frequency of the maximum wavelet coefficient and occupant count with window length set at 30 seconds according to embodiments of the subject technology.

FIG. 16C is a plot showing a relationship between the frequency of the maximum wavelet coefficient and occupant count with window length set at 45 seconds according to embodiments of the subject technology.

FIG. 16D is a plot showing a relationship between the frequency of the maximum wavelet coefficient and occupant count with window length set at 60 seconds according to embodiments of the subject technology.

FIG. 17 is a flowchart of a method of determining room occupancy according to an embodiment of the subject technology.

### DETAILED DESCRIPTION OF CERTAIN EMBODIMENTS

Broadly, embodiments of the subject technology provide building or room occupancy estimation which may be used for energy-efficient building control. Occupant count estimates determined by the embodiments may be used to provide demand-controlled ventilation to connected HVAC (Heating Ventilation and Air Conditioning) systems. The output from the subject technology can provide substantial energy savings over constant ventilation levels while maintaining occupant comfort. RADAR-based occupancy detection and estimation is an attractive approach, as it is unobtrusive and does not introduce privacy issues as compared to for example, video imaging-based sensors. Prior attempts at estimating occupant count with RADAR sensors focused on the Received Signal Strength (RSS) method, and had limited resolution. In the subject disclosure, a time-frequency spectral analysis processing technique is presented for counting the number of people in a building space utilizing microwave Doppler RADAR. In one embodiment, the RADAR signal is processed to determine the frequency of the maximum wavelet coefficient (frequency at which highest amplitude occurs) of a segmented portion of the signal obtained through wavelet transform. Information from the frequency of the maximum wavelet coefficient indicates the number of occupants in a room.

Analysis of the time and frequency content of the signal increases the robustness of the occupant count with the Doppler RADAR system. The Wavelet Transform (WT) is one kind of time-frequency spectral analysis signal processing technique that has shown its efficacy to analyze and extract the characteristics of signals that have non-stationary behavior in applications such as radar fall detection. The RADAR-based occupancy detection signal also has non-stationary behavior as occupants might vary between walking (relatively high frequency) or sitting (low frequency-breathing motion is detected).

A RADAR-based motion sensor with the wavelet-based algorithm described below is used as an illustrative embodiment that provides an accurate assessment of occupancy in a room from a wall-mounted or ceiling-mounted sensor. Offering precise occupant count, this technology can be used to optimize ventilation rate in DCV HVAC systems, reducing energy cost while keeping occupants productive and comfortable. These RADAR-based sensors can provide occupant count without the errors introduced by motion sensors, without the delays and inaccuracies of CO2 sensors, without the privacy issues introduced by video-based sensors, and without the high up-front cost of systems that require a dense array of sensors.

### Microwave Doppler Radar Detection of Respiration of Multiple Occupants

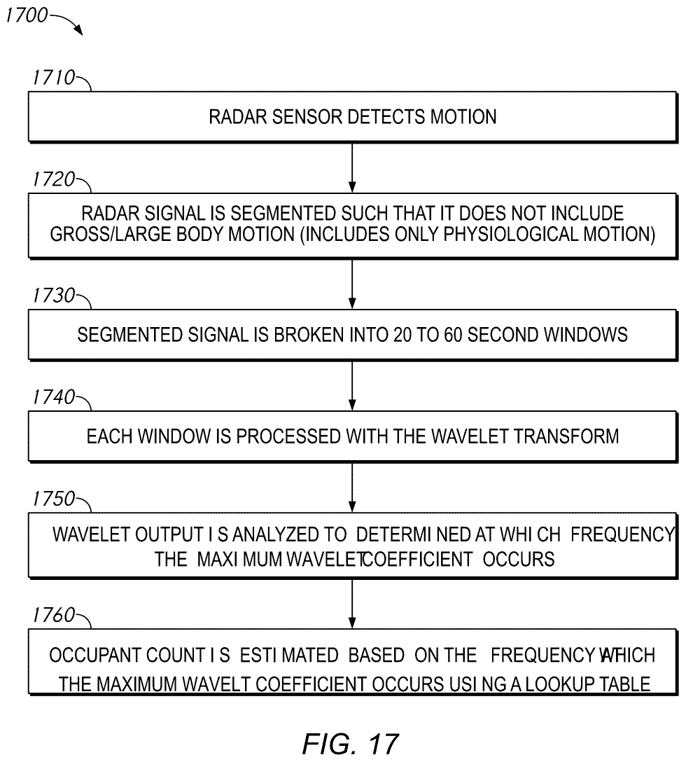

Referring to FIG. 17, a method 1700 of determining room occupancy is shown in according to an illustrative embodiment. Steps of the method 1700 are referenced as blocks followed by a reference number following the format “17xx”. FIG. 17 will be discussed with concurrent reference to other figures.

A microwave Doppler RADAR transmits a continuous electromagnetic signal, and the phase of the reflected signal is shifted directly proportionally to the motion of objects in the room. If a stationary person is present, the phase shift is proportional to the tiny movement of the chest surface due to cardiorespiratory activity. The RADAR sensor detects the motion in block 1710. The baseband output signal from the RADAR can be expressed as:

$${x}_{r} ( t ) = Acos ( \frac{2 π}{λ} ( 2 {d}_{0} + 2 d ( t ) ) ) \qquad ( 1 )$$

Where, λ is the wavelength of the transmitted signal, d₀ is the static distance of RADAR antenna to the human subject, d(t) represents chest displacement due to heartbeat and respiration, and A is the amplitude of the received signal. The signal can be demodulated, and the DC component removed to leave only the time-varying phase signal, S(t). The displacement of the subject's cardiopulmonary movement relates to the phase in the equation above in the form of:

$$S ( t ) = \frac{4 π}{λ} d ( t ) \qquad ( 2 )$$

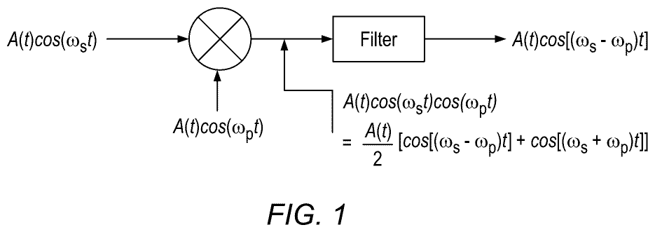

A RADAR receiver consists of non-linear devices such as mixers which also consist of diodes, transistors, or some of the most common types of nonlinear devices which show nonlinear properties such as harmonic, intermodulation, and subharmonic tones when they are subject to fundamental tones. In Doppler RADAR physiological sensing, the fundamental tones are generated by the tiny movement of the chest surfaces due to cardio-respiratory activities. In general, non-linear responses such as subharmonic responses are generated by the frequency divider circuits and harmonic responses are generated by the diodes, transistors. Unlike other non-linear responses, the intermodulation effect is most dominant in the frequency spectrum of the physiological signal as they also help to broaden the spectrum. For simplicity, the intermodulation term generated for the presence of two subjects in front of the RADAR receiver or the presence of two fundamental tones is described. A mixer is fundamentally a multiplier. Considering a scenario where the mixer has two input ports shown in FIG. 1(a). The signal applied to the RF port has a carrier frequency ωₛ and modulation waveform A(t) (This represents double sideband suppressed carrier signal any other type of modulation could be used in this example as well). The local oscillator is operating at a frequency ωₚ. The signal at the mixer's output is represented as:

$$A ( i ) cos ( {ω}_{s} t ) * cos ( {ω}_{p} t ) = \frac{A ( t )}{2} [ cos [ ( {ω}_{s} - {ω}_{p} ) t ] + cos [ ( {ω}_{s} + {ω}_{p} ) t ] ] \qquad ( 3 )$$

In the case of two occupants, the mixer is acting on two RF input signals, summed together.

The output of the mixer consists of modulated components at the sum and difference frequencies. The sum frequency is rejected by the intermediate frequency (IF) filter, leaving only differences. The use of a nonideal multiplier results in the generation of LO harmonics and in mixing products other than the desired outputs. The use of a nonideal multiplier can be illustrated by describing the I/V characteristics of the nonlinear device via a power series,

$$I = {a}_{0} + {a}_{1} V + {a}_{2} {V}^{2} + {a}_{3} {V}^{3} + ⋯ \qquad ( 2 )$$

and letting V equal the sum of the two inputs to the mixer in FIG. 1(a).

In the case of two breathing occupants,

$$V = cos ( {ω}_{s} t ) + {A}_{1} ( t ) cos ( {ω}_{p 1} t ) + {A}_{2} ( t ) cos ( {ω}_{p 2} t ) \qquad ( 7 )$$

The largest signal is respiration, and amplitude modulation Aₙ(t) is minimal and can be estimated as a constant. Simplifying the phase modulation to include only the respiratory signal, and simplifying the respiratory signal to a cosine, the phase modulation from occupant n's physiological motion can be estimated as

$${d}_{n} ( t ) = cos ( 2 π {f}_{n} t ) \qquad ( 8 )$$

With a direct conversion radar, the DC phase shift don can be removed in hardware or software, and the LO and RF signals have the same frequency, ωₛ.

If we expand to include the phase terms, the case of two breathing occupants is

$$V = cos ( {ω}_{s} t ) + {A}_{1} ( t ) cos ( {ω}_{s} t + \frac{2 π}{λ} ( 2 {d}_{0 , 1} + 2 {d}_{1} ( t ) ) ) + {A}_{2} ( t ) cos ( {ω}_{c} t + \frac{2 π}{λ} ( 2 {d}_{0 , 2} + 2 {d}_{2} ( t ) ) )$$

With these simplifications, and after an appreciable amount of algebraic and trigonometric manipulations, the output is found to be a signal with the original modulation, but shifted to the difference frequency. If it is assumed that the voltage of the modulated input signal is much smaller than that of the LO, and two occupants are present, the mixer output current contains small-signal components at the frequencies:

$${f}_{a , b} = {af}_{0} + {bf}_{1} where , a , b = 0 , + 1 , - 1 , + 2 , - 2 , \qquad ( 9 )$$

where f₀ is the fundamental respiratory frequency from occupant 0, and f₁ is the fundamental respiratory frequency from occupant 1. The current also includes harmonics of the LO. Again, it is generally easy to filter out the desired difference frequency. Frequencies other than the fundamental respiratory frequencies are harmonics (where a or b is equal to 0) and intermodulation tones (where both a and b are non-zero).

The amplitude of the of the signals at these frequencies is inversely proportional to the order of intermodulation. Therefore, in most cases, the largest amplitude occurs at a frequency that is the sum of all the fundamental frequencies. This is known as the frequency of the maximum amplitude in time-frequency space, the frequency of the maximum wavelet coefficient (when Wavelet analysis is used to find it.

The order of the intermodulation is calculated by a+b. For example, if there is a presence of two subjects at a breathing rate of f₀=0.25 Hz and f₁=0.3 Hz. Then the 3rd order intermodulation tones 2f₀−f₁ will be at 0.2 Hz and 2f₁−f₀ at 0.35 Hz.

As the number of occupants increases, there are more signals that intermodulate (f₀, f₁, . . . , f_{N-1} with N being the number of occupants present). For example, with 4 occupants present, intermodulation products occur at:

$$( 10 )$$

$${f}_{a , b , c , d} = {af}_{0} + {bf}_{1} + {cf}_{2} + {df}_{3} where , a , b , c , d = 0 , + 1 , - 1 , + 2 , - 2 ,$$

The more occupants present, the more high-frequency content or (intermodulation tone) will be included in the baseband signal, with the highest amplitude frequency content occurring at a frequency that is roughly the sum of all the breathing frequencies. By identifying the frequency with the highest amplitude content of the baseband signal, the number of occupants can be inferred. Additionally, the signal content is more spread in frequency with more occupants, so measures of the spread of the signal in frequency space, such as entropy, can be used infer the number of occupants in other embodiments.

Both analog and digital filters may be used to eliminate some signals out of the band of interest, to avoid aliasing, and to remove noise. In embodiments that use analog filters, they are implemented after the mixer, and before the analog-to-digital converter. The analog filter may be a bandpass filter or a lowpass filter. In some embodiments, a processor in the system may perform digital filtering on the digitized baseband signal, on the extracted portion, or on the segment prior to time-frequency analysis of the signal. In various embodiments, the filter may be a low-pass or band-pass filter. In various embodiments, the filter may be a finite impulse response filter or an infinite impulse response filter. The filter order varies depending on the embodiment. In some embodiments the filter order may have a value between 10 and 10,000.

When a person is walking or making a non-periodic movement, there is a much larger reflection, and therefore a larger received signal. In this work, these non-periodic motions are discarded based on the amplitude of the received signal. For example, when people are walking in a room, the amplitude of the signal is large, and utilizing an amplitude threshold, we can discard that portion. Selecting a segment of the signal that does not include large, non-periodic motion, is referred to as segmentation. (Block 1720). Segmentation is the technique of dividing or portioning periodic signal segments from the aperiodic portion of the signal, or separating smaller portions of the signal from the larger signals. In an illustrative approach, the process is applied to 20 second to 60-second window segments of the periodic signal that remains after discarding such non-periodic motion. (Block 1730). A segmentation technique is used for extracting the periodic portion of the segment. In some embodiments, a maximum amplitude value (for example, 30% of the maximum amplitude signal segment) is used as a qualifying criteria for a periodic portion. The segment may be discarded if it crosses above this amplitude range. In this approach, (Block 1740) the wavelet transform (WT) is used to identify the frequency at which the highest amplitude occurs in time-frequency space of the segmented signal (Block 1750). This can alternatively be described as the frequency at which the wavelet coefficient is greatest. The frequency of the maximum wavelet coefficient is roughly the sum of the respiration frequencies of all the occupants and can be used to estimate the number of occupants in a room when occupants are sedentary. In some embodiments, the information on the number of occupants may be obtained from the frequency of the maximum wavelet coefficient by referencing a look up table (Block 1760). For example, if the frequency associated with the maximum wavelet coefficient is <X1, occupant count is 1, >=X1 and <X2, occupant count is 2, etc.

Since the number of people present and breathing signals are not stationary, in an illustrative embodiment, the analysis of the signals may use a time-frequency spectral analysis method. In various embodiments, the time-frequency analysis may be performed by any suitable approach, including, for example: wavelet analysis, short time Fourier transform, continuous wavelet transform, Gabor transform, bilinear time-frequency distribution function, Wigner distribution function, Gabor-Wigner transform, Hilbert transform, filter banks, or windowed Fourier transform.

Following the time-frequency analysis, the computer implemented method will have an indication of the spectrum of the signal over time. In various embodiments, the distribution of frequencies in these time-varying spectra is then analyzed by one or more of a number of approaches to estimate the number of people.

One embodiment is looking at the highest frequency components of significant amplitude in the signal. The highest frequency intermodulation product's frequency increases with the number of occupants. Another embodiment is calculating the entropy of the frequency distribution, because the spectra are “smeared” by intermodulation of the signals. Another embodiment is identifying the frequency at which the largest amplitude occurs in time-frequency space. Another embodiment is analyzing the ratio of the highest amplitude frequency components to the average amplitude.

In some embodiments, the time-frequency analysis may be used in conjunction with analysis of the amplitude of the reflected signal and/or the amplitude of the baseband signal, via any of several possible analysis approaches, including but not limited to root mean square of the signal.

### Wavelet Transform

The Fourier transform (FT) is one well suited tool to analyze for stationary signals, as it operates on fixed windows of data and divides the frequency range into equally sized bins to find the frequency of the maximum amplitude in time-frequency space. When the signal contains high-frequency components for short durations and low-frequency content for long periods (common in non-stationary signals), the FT may be inadequate for analyzing a mixture of the higher and lower frequency content of the signal, because of the tradeoffs between temporal resolution and spectral resolution. Wavelet transform (WT) has been developed to better examine non-stationary signals (which may be for example, signals of subjects that are changing over time), eliminating the temporal-spectral resolution tradeoffs. Radar-based occupancy sensing in realistic environments involves the detection of multiple people. When multiple occupants are in the radar field of view, intermodulation tones are generated due to the nonlinearity of the radar receiver. This spurious product consists of the mixture of different intermodulation tones (such as 2f₁+f₂, 2f₁−f₂, 2f₂+f1, and so on). This intermoduation product consists of high frequency and a larger amount of low frequency signal. This kind of signal behavior makes the WT a good choice for analyzing the frequency of the maximum amplitude in time-frequency space of the segmented portion of the signal. The continuous WT of a signal x(t) is defined as:

$$x ( τ , a ) = \frac{1}{\sqrt{a}} \int x ( t ) f ⋆ ( \frac{t - τ}{a} ) dt \qquad ( 5 )$$

Where, x(t) is the time series signal being processed, τ(τ>0) is a shift factor, a is a scaling factor, and

$$f ⋆ ( \frac{t - τ}{a} )$$

is the daughter wavelet which is a scaled and shifted version of the mother wavelet f(t). The basic idea behind the WT is that the mother wavelet is scaled by a relating to frequency and shifted along x(t) depending on t to form a daughter wavelet

$$f ( \frac{t - τ}{a} )$$

and then the similarity of daughter wavelet to x(t) is computed and recorded in the WT coefficient. By repeating the above steps for all a and τ until the whole time-series signal and frequencies of the interests are covered, a coefficient matrix is obtained. This approach not only provides the spectral information through scaling but also provides the time domain information via shifting the wavelet across the signal.

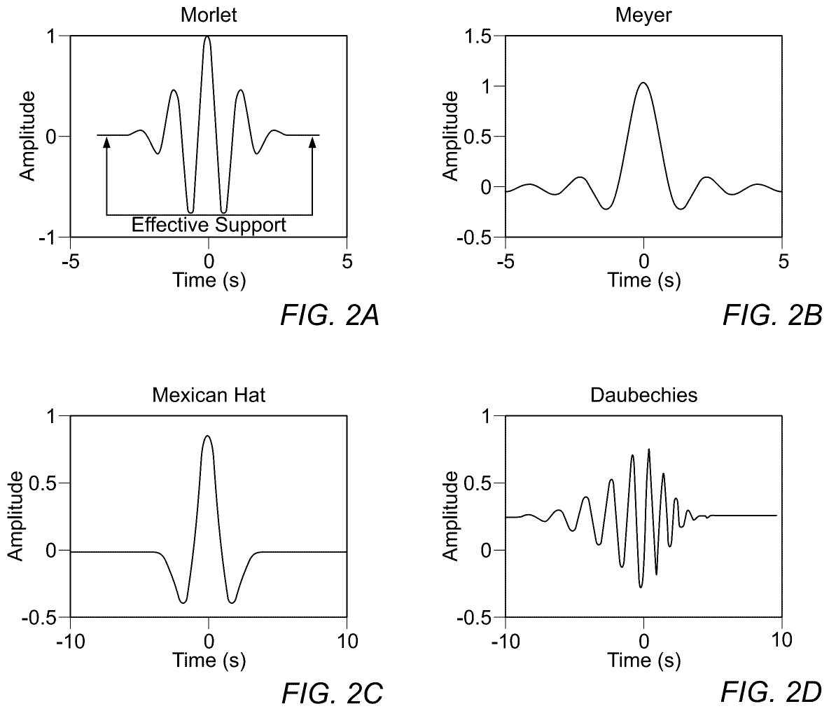

Many mother wavelets are used in various applications; four commonly used mother wavelets are shown in FIGS. 2A, 2B, 2C, and 2D. In physiological processing, the Morlet wavelet is commonly used because of its utility in time and frequency localization of periodic physiologic signals, which facilitates isolation of the frequency of the maximum wavelet coefficient. Having multiple maxima within the mother wavelet is important for physiological signal processing. In general, the continuous wavelet transform provides excellent time resolution for higher-frequency high-order intermodulation products and good frequency resolution for lower-frequency events such as the fundamental frequency of respiration. In this work, Morlet wavelet is chosen as the mother wavelet to detect the frequency content of signals with many occupants and significant intermodulation, as well as the sub-Hertz frequency content of individual respiratory signals. It is used in this application because of its simple numerical implementation and because the third-order differentiation of its phase vanishes, which reduces computational complexity, which can be beneficial for real-time processing and/or on-chip processing. The Morlet wavelet, which is defined as

$${e}^{- \frac{{x}^{2}}{2}} cos ( 5 x ) ,$$

is chosen as the mother wavelet in this work.

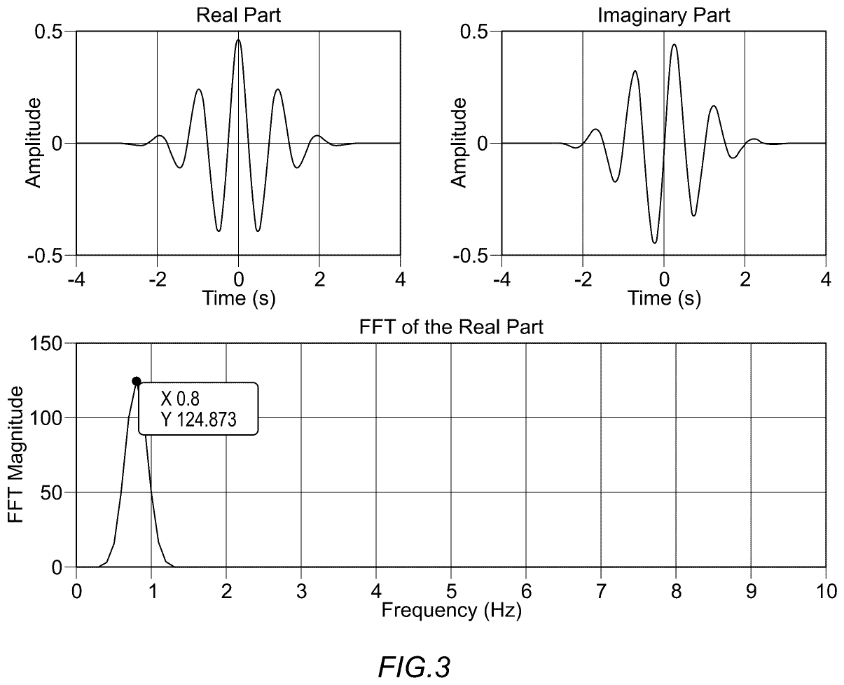

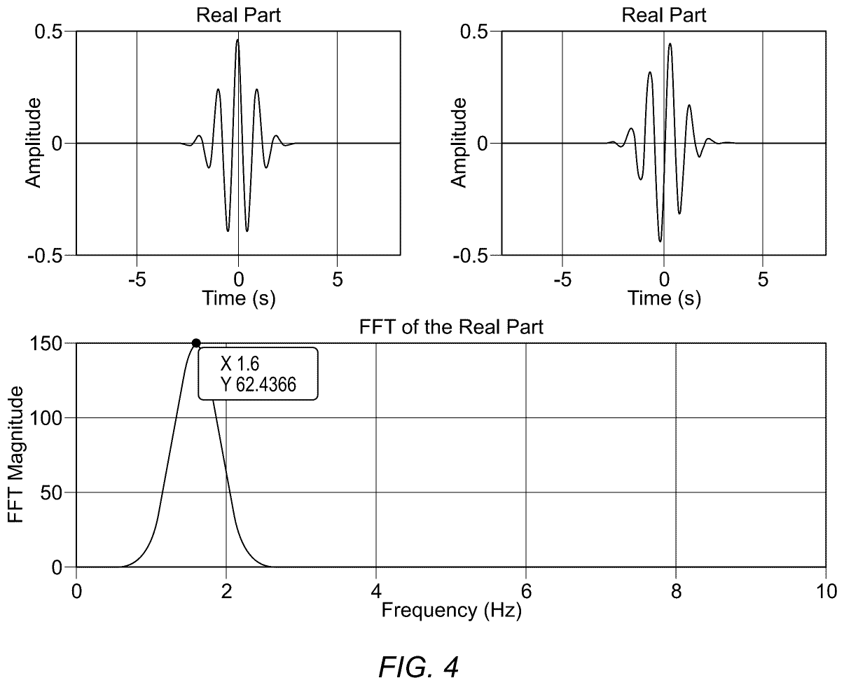

Mother wavelets, including the Morlet wavelet, have what is known as “effective support,” which represents the non-zero interval of the mother wavelet. As shown in FIG. 2A, the default effective support of the Morlet wavelet is [−4 4], which corresponds to about 4 cycles of a sinusoidal signal with its amplitude windowed with a Gaussian. However, the effective support can be changed to adjust the lower and upper limits of the integral. In general, effective support changes the length of the lower and upper limits of the integral. A sedentary respiration cycle is typically from 3-8 seconds long. Different effective supports of the Morlet wavelet were analyzed, indicating that when effective support increases, then the spectrum of the Morlet wavelet broadens. For example, FIG. 3 shows that in the FFT spectrum the fundamental frequency in the spectrum is around 0.8 Hz when the effective support is at the default setting of 8 ([−4 4]). If the effective function is increased to 16 ([−8 8]) then the spectrum broadening occurs, and the fundamental frequency is around 1.6 Hz shown in FIG. 4. The higher fundamental frequency is closer to the frequencies of the intermodulation components, enabling better resolution of these components.

### Modelling of Occupancy Estimation

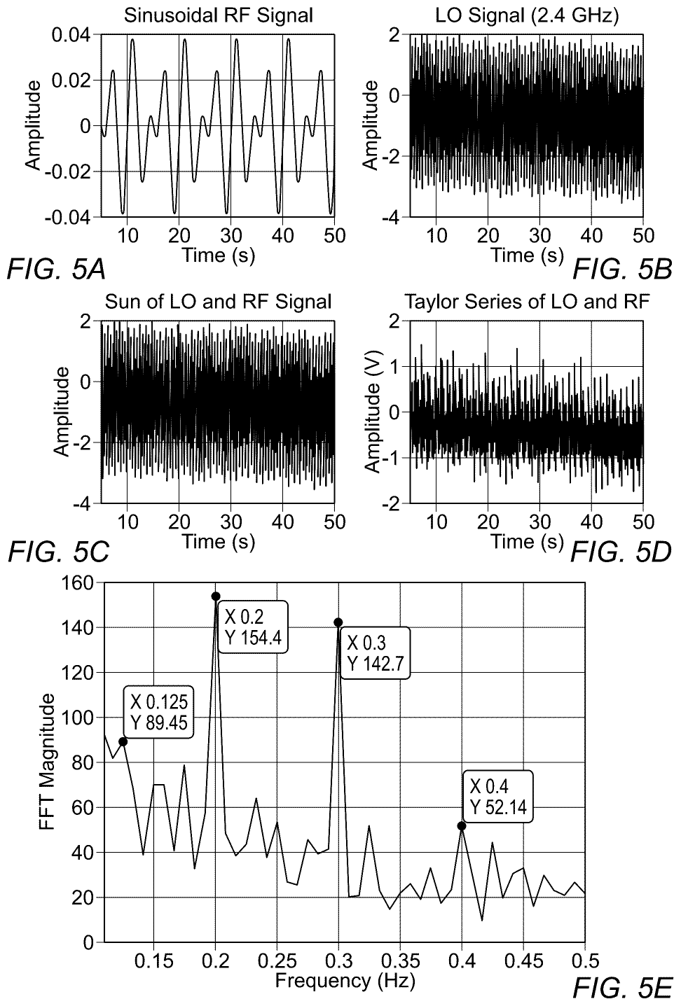

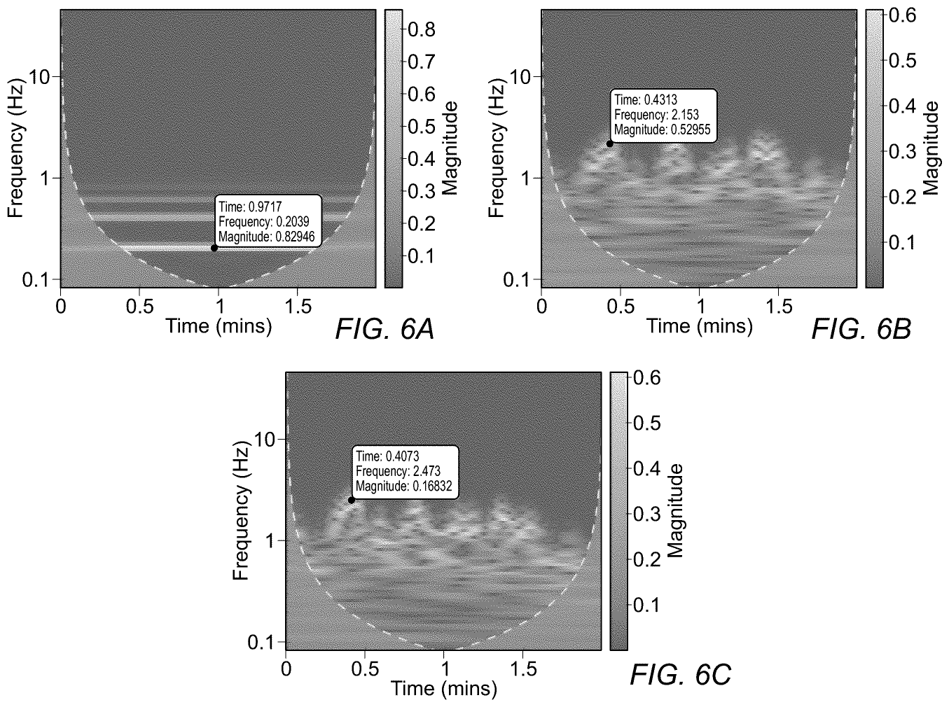

To better understand the time-frequency content of the intermodulation tone of signals from a RADAR sensor detecting breathing from multiple occupants, different scenarios in MATLAB were simulated. Sinusoidal signals were generated having different frequency contents within the range of the respiration signals (0.2-0.4 Hz) that are not multiples or harmonics of each other. A 2.4 GHz local oscillator signal was generated and it was mixed with the sinusoidal respiration signal containing multiple breathing frequencies. After mixing the generated LO signal with the respiration signal, the Taylor series of the combined mixture to illustrate the nonlinear characteristics of the mixer may be computed. A fast Fourier transform (FFT) may be performed, and wavelet transform (WT) of the Taylor series of the combined signal may be performed to extract the frequency of the maximum amplitude in time-frequency space (intermodulation tone) of the signal. FIGS. 5A-5B, 5C, 5D, and 5E illustrate a combination of two sinusoidal signals having frequencies 0.2 Hz and 0.3 Hz and mixed with a 2.4-GHz local oscillator signal. The FFT peak shows the fundamental frequency with the intermodulation tones. For having a fundamental frequency of 0.2 and 0.3 Hz, there are minor peaks at 0.4 Hz and 0.125 Hz which is the intermodulation tone due to the non-linearity of the mixers. For further investigations, a method may generate different frequency ranges, 0.2 to 0.4 Hz of the sinusoidal signal and mixed with LO frequency. WT may be performed with an effective support of eight to extract the frequency of the maximum wavelet coefficient of the segmented signal. This also helps us to better understand the correlation between the frequency associated with the maximum wavelet coefficient of the mixed signal from the mixture of fundamental tones. A mixture of frequencies of signals may be generated up to ten (0.2 Hz, 0.211 Hz, 0.222 Hz, 0.234 Hz, 0.243 Hz, 0.251 Hz, 0.267 Hz, 0.275 Hz, 0.289 Hz, 0.294 Hz) and may be combined with the LO 2.4 GHz signal. In these simulations, the frequency associated with the maximum amplitude wavelet coefficient, is roughly the sum of all simulated respiratory frequencies in the simulated multiple-occupant signal. FIGS. 6A, 6B, and 6C illustrate that for the frequency associated with the maximum amplitude wavelet coefficient, the signal was 0.2 Hz for one frequency, 2.153 for combining nine frequencies, and 2.473 Hz for combining ten different frequencies.

### Hardware Prototype Field Test

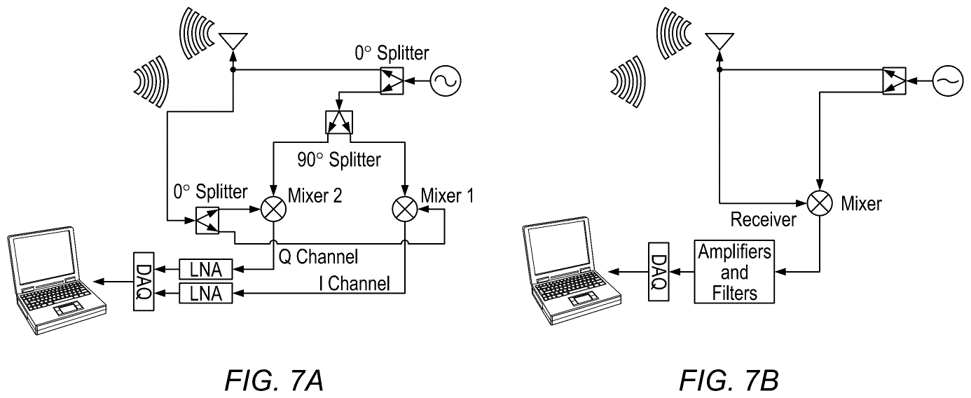

Referring now to FIGS. 7A and 7B, two systems for detecting occupancy are shown as illustrative examples. In FIG. 7A, a quadrature transceiver is used for an initial experiment in a classroom environment for small-scale studies. In FIG. 7B, a single ended transceiver is used.

For our initial experiment, a custom 2.4 GHz Doppler RADAR with a quadrature receiver is illustrated in FIG. 7A. The radio signal source is a 2.4 GHz continuous wave signal from a signal generator. The signal generator output is split between the receiver local oscillator (LO) and transmitter. The transmitter output power of the RADAR at the antenna is about 7 dBm. A 90-degree power splitter is used to split the LO into the I and Q channels which go to their respective mixers for the quadrature receiver. The backscattered signal is received at the antenna and split with a 0-degree power splitter to the I and Q channels which input to the mixers. The received signal is downconverted by mixing with the LO signals at each mixer, and after filtering and amplification, the signal is digitized and recorded. The phase-modulated signal at quadrature receiver after down-conversion is given by:

$${B}_{1} ( t ) = {A}_{BI} cos ( \frac{4 π {d}_{o}}{λ} + \frac{4 π x ( t )}{λ} + Δ ϕ ( t ) ) \qquad ( 4 )$$

$${B}_{Q} ( t ) = {A}_{B Q} sin ( \frac{4 π {d}_{o}}{λ} + \frac{4 π x ( t )}{λ} + Δ ϕ ( t ) ) \qquad ( 5 )$$

where, B_{I}(t) is the in-phase signal, B_{Q}(t) is the quadrature-phase signal, dₒ, is the distance from the RADAR to the human subject, λ is the wavelength, x(t) are the chest displacement and Δϕ(t) is the phase noise of the local oscillator. The phase information, θ(t) can be extracted by utilizing linear or arctangent demodulation. Linear demodulation is a technique in which eigenvalue decomposition is employed to find the maximum displacement information from the quadrature channel signal. For this work, a linear demodulation technique may be used for extracting displacement information from the quadrature signal. An investigation of the efficacy of occupancy detection with a single receiver channel versus a demodulated quadrature signal indicated minimal benefits for using a quadrature receiver for this application. Therefore, a single channel transceiver can also be used; this version is less expensive in hardware and signal processing requirements, which has advantages as the device is integrated into a commercial product.

FIG. 7B shows hardware circuitry of a single-ended radar transceiver in an illustrative embodiment. The generated RF signal is split into a local oscillator (LO) and transmitted output signal with a 0° power splitter. The LO signal is input to the LO port of the mixer. The transmit signal (RFout) is radiated by the antenna. The backscattered signal is received by the antenna and fed directly to the mixer, where it is downconverted by mixing it with the LO. The baseband signal output from the mixer is input to amplifiers and filters which make up a signal conditioning circuit and then is digitized by the data acquisition system (DAQ), which in some embodiments, may be an analog-to-digital converter (ADC) of a system on a chip. In one embodiment, the amplifiers and filters of the baseband signal conditioning circuit consist of three stages: a single-pole high pass filter with 0.1-Hz cut-off frequency, an instrumentation amplifier with adjustable gain, and a single-pole low pass filter with 50-Hz cut-off frequency.

### Experimental Setup and Proposed Methodology

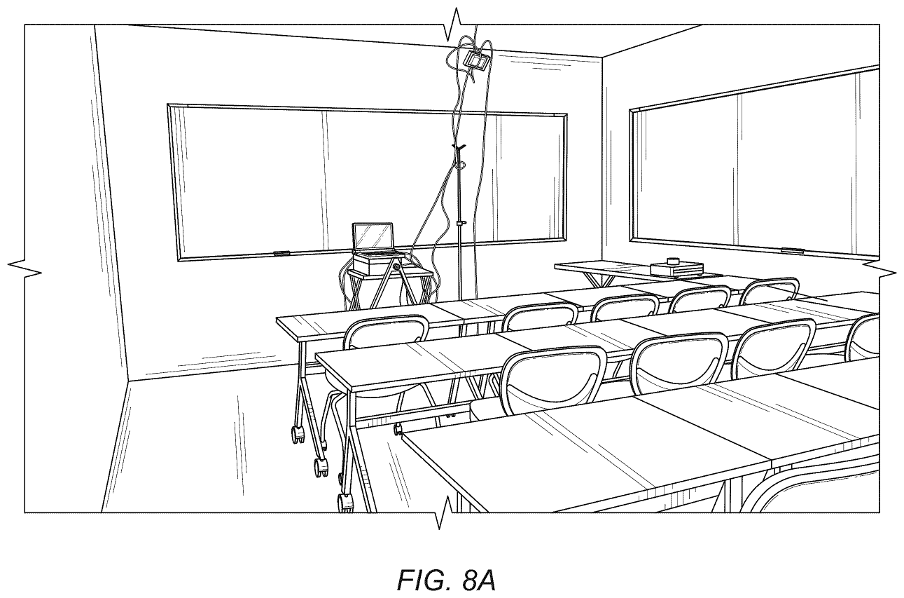

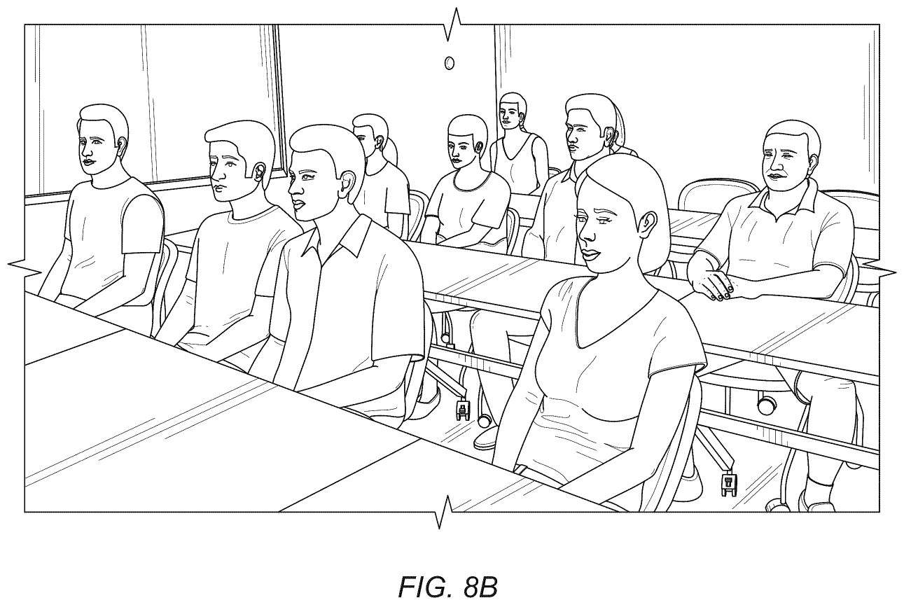

The proposed method was tested in a controlled experiment in a small classroom. In the experiment, a quadrature RADAR was used in a 257 ft² classroom occupied with ten different participants. In the classroom, the first row was 1.5 m away from the antenna, the second row was 3 meters away, and the third row was 4.6 m away. The antenna is mounted at a height of 2.2 meters, at an angle of 60°, to be directed towards the middle of the classroom. FIG. 8A shows the angle of 60°, to be directed towards the middle of the classroom. FIG. 8A shows the experimental setup. The experiment begins with one subject sitting in the front row, next to the wall and one more occupant is added every 90 seconds until 10 occupants were in the room. See FIG. 8B.

RADAR output is recorded for 23 minutes. This data contains people walking and then sitting in the room and then leaving the room one by one.

After data acquisition, the signal was digitally filtered using a low pass finite impulse response (FIR) filter in the order of 1000 with a cut-off frequency of 20 Hz. Because the physiological signal bandwidth is primarily within 0-5 Hz, the signal was filtered within the bandwidth of 20 Hz to concentrate on physiological-related information and its intermodulation products. The wavelet transform was used on the segmented portion of the signal to estimate building occupancy based on the frequency at which maximum amplitude occurs (frequency of the maximum wavelet coefficient).

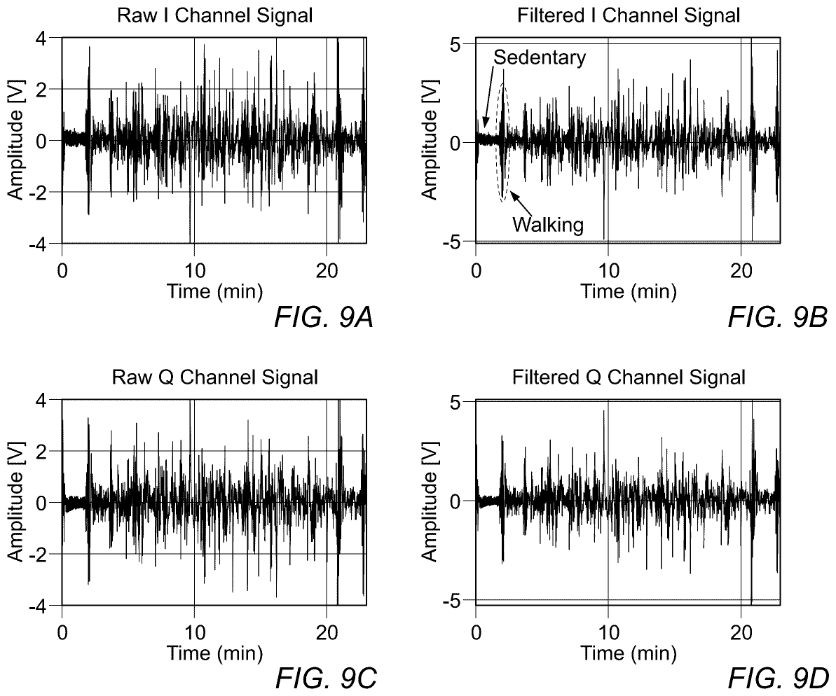

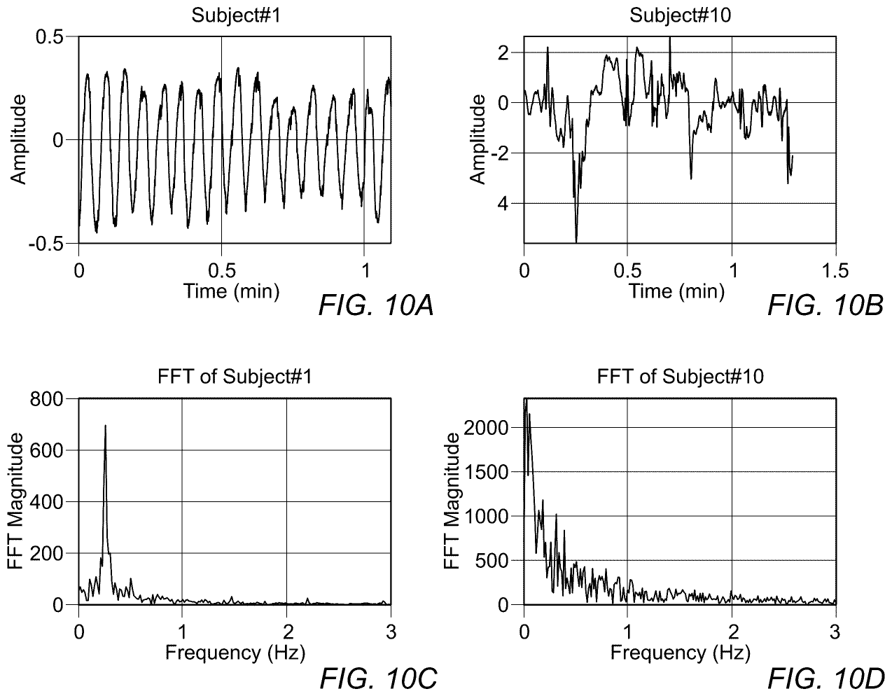

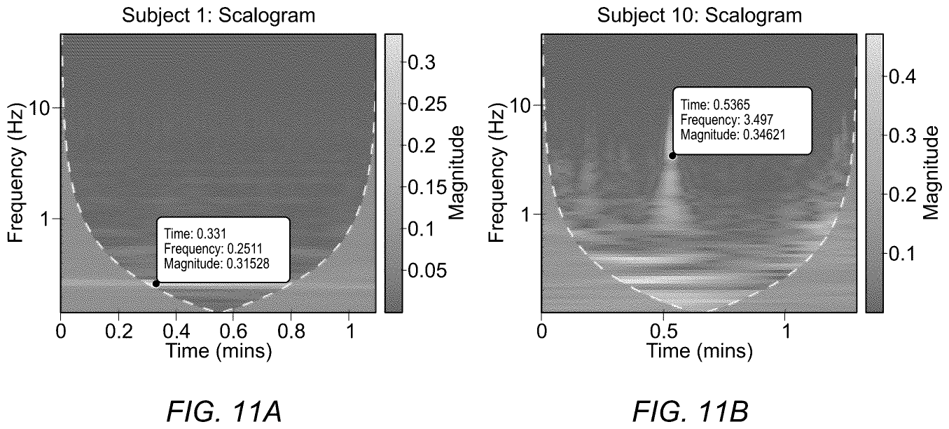

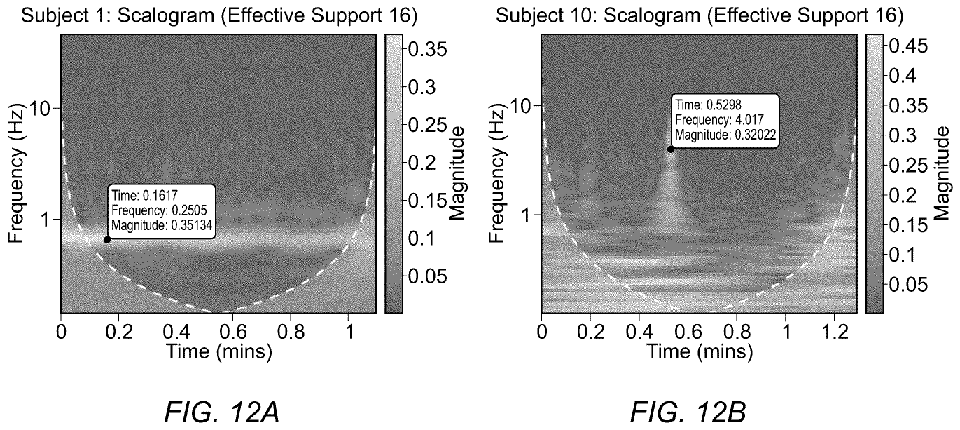

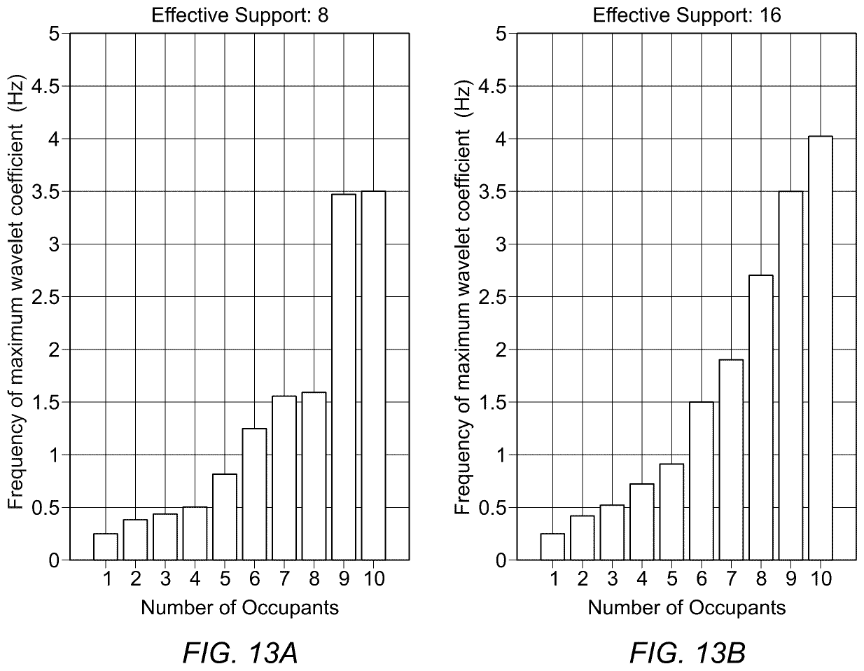

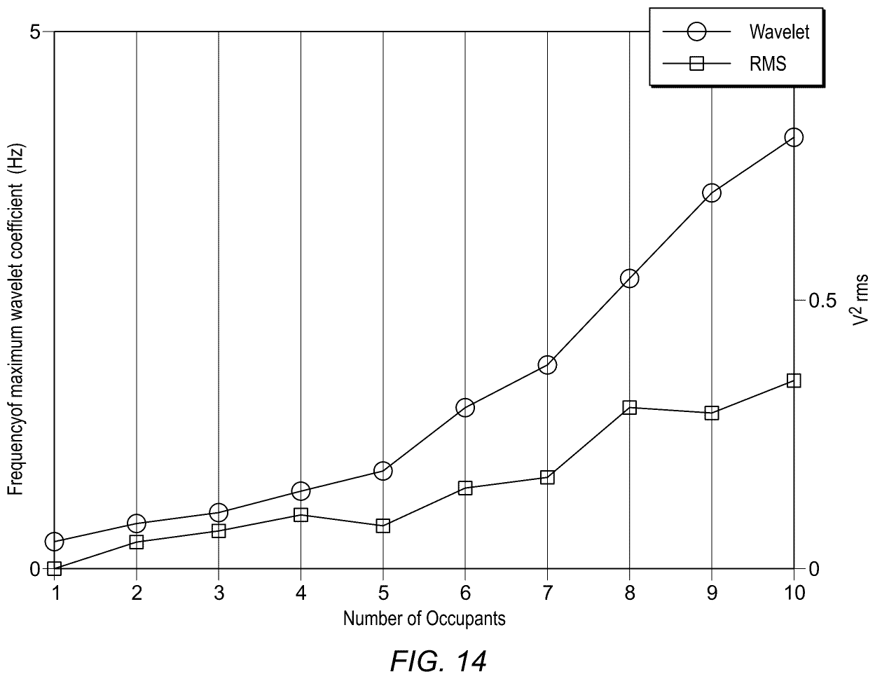

FIGS. 9A, 9B, 9C, and 9D illustrate the captured I and Q channel signals and the filtered versions of the signals. Because filtering is also implemented in hardware by low noise amplifiers (LNA), the digital filter does not have a large impact on the signals. FIGS. 9A, 9B, 9C, and 9D also include some large spikes at 90-second intervals as new occupants entered the room and after walking a bit took a seat. Then the signal was segmented based on amplitude and linearly demodulated to extract the displacement information from the quadrature signal. Therefore, only the part of the signal while occupants were mostly stationary was used for Wavelet analysis (WT). FIGS. 10A-10D illustrate the linearly demodulated signal when one occupant was in the classroom (FIGS. 10A and 10C) and ten occupants were in the classroom (FIGS. 10B and 10D). As the number of occupants increases, the periodicity of the signal decreases, and it contains a mixture of lower and higher frequency content as people sit after walking. When there are multiple subjects present in the RADAR field of view, the RADAR receives a combined mixture of breathing patterns which is the combination of smaller frequency breathing rates. Thus, the frequency at which maximum amplitude occurs in time-frequency space will increase with the number of participants in a room. After segmentation, a 60 second window was identified to use for analysis. Then the signal was linearly demodulated, and the continuous wavelet transform was performed with the analytic Morlet wavelet transform with an effective support of eight. The highest amplitude in wavelet space was identified. In summary, the wavelet transform of the segmented portion of the signal was used to extract the frequency of the maximum wavelet coefficient of the segmented 60 second window of data for each additional occupant. As the number of participants in the room increased, the frequency at which the highest amplitude occurs also increased. The results of the wavelet transform are shown in FIGS. 11A and 11B. The frequency at which the highest amplitude in the scalogram of the segmented signal after Wavelet Transformation occurs is 0.25 Hz with a single occupant, and it is 3.5 Hz with ten occupants. Analysis indicates that if the number of occupants in a room increases, the frequency associated with the maximum wavelet coefficient of the segmented portion signal also increases. Based on analysis, when the effective support number of the wavelet function increases, the extracted frequency associated with the maximum wavelet coefficient varies more consistently with the number of occupants. This increase in variation occurs due to the widening of the spectrum of the wavelet function and at the same time widening of the spectrum of the received RADAR echo shown in FIGS. 10A-10D. FIGS. 12A and 12B show the frequency of the maximum wavelet coefficient of the segmented portion of the signal when the number of the occupants was one and the number of the occupants was ten using the Morlet wavelet function with the effective support number of sixteen. This wavelet-based extracted frequency represents the highest peak in the time-frequency domain of the segmented portion of the signal. The frequency of the maximum wavelet coefficient is proportional to the number of occupants in the classroom. Then the trend between the frequency of the maximum wavelet coefficient of the segmented portion of the signal with the number of occupants was explored. FIGS. 13A and 13B illustrate the trend between the frequency of the maximum wavelet coefficient and the number of occupants. From the figures, the increase of the occupants is associated with an increase in the frequency of the maximum wavelet coefficient of the signal. The increase in the effective support also broadens the spectrum of the mother wavelet and therefore, provides better results with the increase of the number of occupants in the received RADAR echoes. The variation is significant when the effective support number is higher as shown in FIG. 13B.

To test the efficacy of the proposed method, the proposed method results were compared with results from the Received Signal Strength (RSS) method. The received signal strength was calculated as the root mean square of the linearly demodulated segmented signals. FIGS. 11A and 11B show the comparative graph between the variation of frequency of the maximum wavelet coefficient and RSS with the number of occupants. Because the frequency of the maximum wavelet coefficient is monotonically increasing with occupant count, and RSS is not, the frequency of the maximum wavelet coefficient method is a better approach for occupant count estimation. This irregularity in the RSS signal can be caused by some subjects being obscured by others, resulting in a smaller effective RADAR cross-section (ERCS). On the other hand, there is an increase in frequency of the maximum wavelet coefficient with the increase in the number of occupants as their respiratory frequencies are summed in the output. Another possible source of error for the RSS approach could be the antenna placement, where, since it was more focused on the front row of occupants. Sensitivity to antenna placement is another downside of the RSS approach.

The frequency of the maximum wavelet coefficient determined with the wavelet-based analysis of the subject technology shows a monotonically increasing trend with occupant count unlike the RSS method, and therefore it may be a superior approach for occupant count estimation.

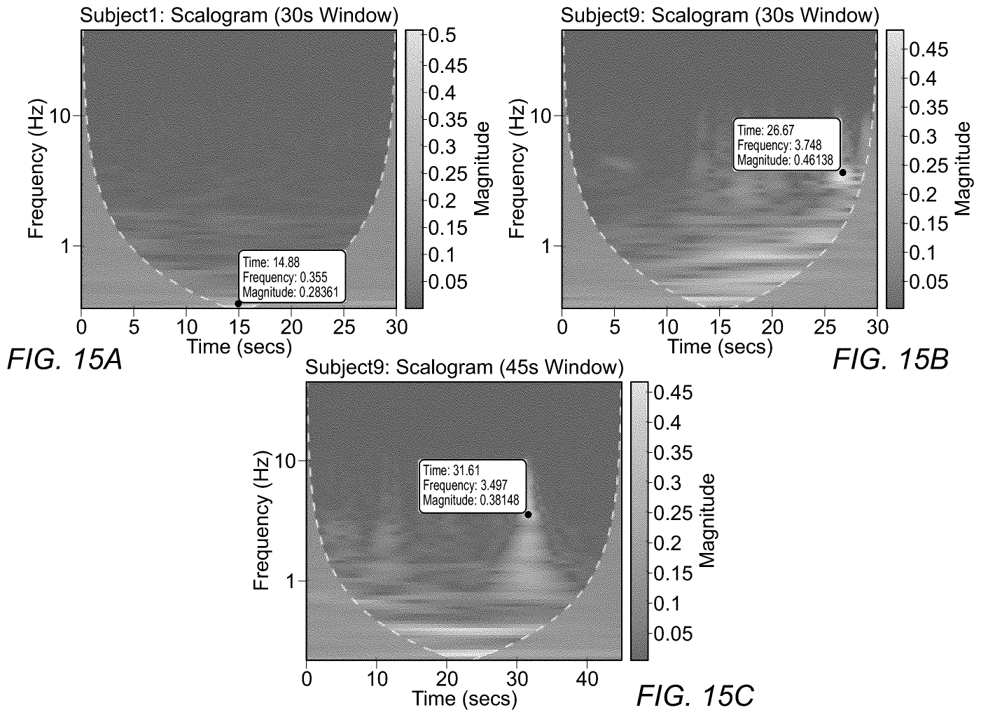

In some embodiments, the reliability of the relationship between frequency of the maximum wavelet coefficient and the number of occupants with the different window sizes of the segmented portion of the signal may vary. Variable sliding windows may be used for the segmented portion of the signal to evaluate the relationship between frequency of the maximum wavelet coefficient and the number of occupants. FIGS. 15A, 15B, and 15C illustrate the wavelet analysis of the segmented portion of the signal for variable window length. FIGS. 15B and 15C show that the segmented portion for the presence of nine occupants with a 30-second and 45-second window, with respective frequencies associated with the maximum wavelet coefficients of 3.748 Hz and 3.497 Hz.

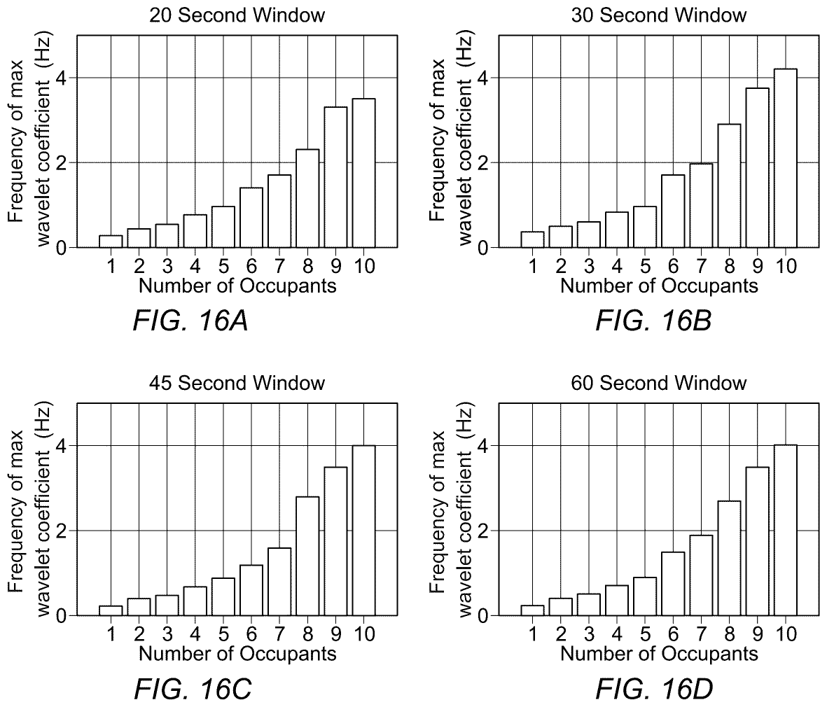

With the change of window length, the frequency of the maximum wavelet coefficient changes as it depends on the signal pattern within the window. However, there is still a monotonically increasing relationship between the frequency of the maximum wavelet coefficient and the number of occupants with all tested window lengths. FIGS. 16A, 16B, 16C, and 16D illustrate the relationship between the frequency of the maximum wavelet coefficient with the number of occupants for varying window lengths. When the window size crosses above 40-seconds the frequency of the maximum wavelet coefficient perfectly matches with that of the full 60-second periodic segmented window. The data show that regardless of the window size, there exists a strong relationship between frequency of the maximum wavelet coefficient and the number of occupants, and that the association may be more consistent for longer window lengths up to 45 seconds.

In various embodiments, the computer implemented method may be performed in real-time, with a delay, or in post-processing. RADAR may be used alone or in conjunction with other occupant count sensors. It may be performed on a processor integrated with the sensor, in a computer attached to the computer, in a remote computer, or in the cloud.

In some embodiments, to enable the wavelet transform to operate on an embedded processor such as a digital signal processor (DSP) chip or a system on a chip (SOC), the computational complexity and memory requirements must be reduced versus the wavelet transform performed on a personal computer or server. In one embodiment, the computational complexity is reduced by rewriting the wavelet transform to use fixed point arithmetic or integer arithmetic rather than floating point arithmetic. In another embodiment, computational complexity is reduced by simplifying the wavelet used for the transform. The simplest wavelet is the Haar wavelet, and this is used in some embodiments. In some embodiments, memory requirements are reduced by reducing the buffer size to the minimum required to obtain the necessary features. In some embodiments, the buffer size is adaptively changed to use the minimum needed at all times. By only storing features extracted from the wavelet transform, data storage requirements are minimized.

In one embodiment, a computer implemented method is applied to ensure the sensor system is only utilizing the more power-hungry wavelet processing when needed. A simpler time-domain signal analysis may be performed to determine whether or not the room is occupied, and only when the room is occupied, is the occupant count process performed. In some embodiments, to further save on power-hungry computation, once the occupant count is estimated and confirmed, it can be assumed that the occupant count does not change unless the sensor detects a large movement, which could indicate a person entering or leaving the room. The occupant count only needs to be re-calculated following detection of such a large movement with simple time-domain processing. This can reduce the power consumption, potentially enabling Doppler radar occupant count estimation to operate on battery power.

The implementation of some or all of these techniques reduces the computational complexity and memory requirements of the wavelet transform for Doppler radar occupant count estimation, enabling the system to use a low-cost, off-the-shelf chip for processing.

In some embodiments, the computing device controlling the system may operate the processes described above in the general context of computer system executable instructions, such as program modules, being executed by a computer system. The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described above.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon. In some embodiments, the raw baseband data will be sent over a wired network, wireless network, and/or the internet to another computer for processing. In some embodiments, the processor performing the time-frequency analysis may be one or more processors in one or more cloud-based computers. In cloud based embodiments, resources may be gathered from different computing devices connected to each other through a cloud network.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processing unit of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A method for determining occupancy in a room, comprising:
operating a RADAR based sensor to detect human movement in a room;
receiving, by a processor, a baseband signal from the RADAR based sensor;
extracting, by the processor, a segment of the baseband signal;
extracting, by the processor, a portion of the segment;
applying, by the processor, a time-frequency spectral analysis to the extracted segment;
identifying, by the processor, a distribution of signal over frequencies and time in the extracted segment based on the time-frequency spectral analysis; and
determining, by the processor, a number of occupants present in the room based on parameters associated with the distribution of signal over frequencies and time.

2. The method of claim 1, further comprising processing the segment in the event a signal level is below a maximum amplitude value of the segment of the portion of the baseband signal and discarding the segment if the signal level crosses above the maximum amplitude value.

3. The method of claim 1, further comprising:
evaluating multiple segments of the baseband signal;
applying the time-frequency spectral analysis to each of the multiple segments;
identifying, for each segment, a frequency associated with a signal maximum in the distribution of signal over frequencies and times; and
determining that in an event the frequency of the signal maximum of a first segment is higher than the frequency of the signal maximum of a second segment, a number of occupants associated with the first segment is higher than a number of occupants associated with the second segment.

4. The method of claim 1, wherein the time-frequency spectral analysis includes processing a wavelet transform to determine the distribution of signal over frequencies and time.

5. The method of claim 4, further comprising selecting a Morlet wavelet for analysis in processing the wavelet transform.

6. The method of claim 1, further comprising discarding aperiodic movement data from the extracted segment.

7. The method of claim 1, further comprising analyzing sliding windows of the segmented portion of the signal to determine the number of occupants over time.

8. The method of claim 5, further comprising identifying a frequency associated with a maximum wavelet coefficient in the extracted segment, wherein the frequency associated with the maximum wavelet coefficient identified represents intermodulation of respiratory movements and the frequency associated with the maximum wavelet coefficient is used to determine the number of occupants in the room.

9. A system for detecting occupancy in a room, comprising:
a RADAR based sensor; and
computing device connected to the RADAR based sensor, wherein the computing device includes a processor configured to:
operate a RADAR based sensor to detect human movement in a room;
receive a baseband signal from the RADAR based sensor;
extract a segment of the baseband signal;
extract a portion of the segment;
apply a time-frequency spectral analysis to the extracted segment;
identify a distribution of signal amplitude over frequencies and time in the extracted segment based on the time-frequency spectral analysis; and
determine a number of occupants present in the room based on parameters associated with the distribution of signal amplitude over frequencies and time.

10. The system of claim 9, wherein the processor is further configured to process the segment in the event a signal level is below a maximum amplitude value of the segment of the portion of the baseband signal and discarding the segment if the signal level crosses above the maximum amplitude value.

11. The system of claim 10, wherein the processor is further configured to:
evaluate multiple segments of the baseband signal;
apply the time-frequency spectral analysis to each of the multiple segments;
identify, for each segment, a frequency associated with a signal maximum in the distribution of signal over frequencies and times; and
determine that in an event the frequency of the signal maximum of a first segment is higher than the frequency of the signal maximum of a second segment, a number of occupants associated with the first segment is higher than a number of occupants associated with the second segment.

12. The system of claim 11, wherein the time-frequency spectral analysis includes processing a wavelet transform to determine the distribution of frequencies.

13. The system of claim 12, wherein the processor is further configured to select a Morlet wavelet for analysis in processing the wavelet transform

14. The system of claim 9, wherein the processor is further configured to discard aperiodic movement data from the extracted segment.

15. The system of claim 9, wherein the processor is further configured to analyze sliding windows of the segmented portion of the signal to determine the number of occupants over time.

16. The system of claim 13, wherein the processor is further configured to identify a frequency associated with a maximum wavelet coefficient in the extracted segment, wherein the frequency associated with the maximum wavelet coefficient identified represents intermodulation of respiratory movements and the frequency associated with the maximum wavelet coefficient is used to determine the number of occupants in the room.

17. A RADAR based sensor system for detecting occupancy in a room, comprising:
a local oscillator;
a power splitter;
a mixer, wherein:
a radio signal from the local oscillator is split into a first portion of the radio signal and into a second portion of the radio signal,
the first portion of the radio signal is sent from the local oscillator to an antenna to drive an emitted detection signal and generate a return signal from one or more objects in the room,
the second portion of the radio signal and the return signal are sent to the mixer, and
the mixer generates an output of a baseband signal as a product of the second portion of the radio signal and the return signal;
a baseband signal conditioning circuit is disposed to receive the output baseband signal from the mixer and filter and amplify the baseband signal from the mixer;
a data acquisition circuit disposed to digitize the output of the baseband signal conditioning circuit and outputting a digitized baseband signal; and
a computing device connected to the baseband signal conditioning circuit, wherein the digitized baseband signal is processed by a processor in the computing device to:
extract a segment of the baseband signal;
extract a portion of the segment;
apply a wavelet transform to the extracted portion of the segment;
identify a frequency associated with a maximum wavelet coefficient of the extracted portion of the segment based on the wavelet transform;
determine a number of occupants present in the room based on information in the frequency associated with the maximum wavelet coefficient; and
control an environmental control system of the room based on the determined number of occupants.
